(19) United States
(12) Patent Application Publication
(10) Pub. No.: US 2009/0286637 A1
(43) Pub. Date: Nov. 19, 2009

(54) TENSIONING DEVICE FOR A TRACTION MECHANISM, IN PARTICULAR A BELT OR A CHAIN

(75) Inventors: Hermann Stief, Emskirchen (DE); Michael Bogner, Eckental (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/302,588

(22) PCT Filed: May 15, 2007
(86) PCT No.: PCT/EP2007/054683

§ 371 Date: Nov. 26, 2008

(30) Foreign Application Priority Data
Jun. 9, 2006 (DE) 102006026847.4

(51) Int. Cl. F16H 7/12

(52) U.S. Cl. 474/135

(57) ABSTRACT

A tensioning device for a traction mechanism, in particular a belt or a chain, is provided including a lever arm (2, 19) over which the traction mechanism is guided and on which a tensioning spring is arranged with its one end, the other end of the tensioning spring is arranged on a spring holder (6, 21), by which the tensioning device (1, 18, 30) can be fastened to an external object. A holding element (11, 22, 34), which extends from the lever arm (2, 19) to the spring holder (6, 21) and is detachably arranged on both said lever arm (2, 19) and said spring holder (6, 21), holds the tensioning device (1, 18, 30) in a position with a preloaded tensioning spring (4, 20, 33).

### BACKGROUND

The invention relates to a tensioning device for a traction mechanism, in particular, a belt or a chain, comprising a lever arm over which the traction mechanism is guided and on which a tensioning spring is arranged with its one end and whose other end is arranged on a spring holder by which the tensioning device can be fastened to an external object.

Such a tensioning device is known, for example, from DE 195 01 685 C1. So that the assembly of this tensioning device is simplified, the tensioning device described there has a connection element that can be set in tension in the form of a spring band strip that extends from the spring holder to the lever arm, wherein a tensioning spring is provided in a known way between both the spring holder and the lever arm. With the lower end, the spring band strip is fixed on the spring holder by a pin inserted into a borehole. The spring band strip passes through the tensioning spring in its interior and is guided by a spring support that is provided on the lever arm and on which the tensioning spring is supported with its other end. On the end of the spring band strip, another pin that is engaged transversely is provided whose end is rotated by 90° to the strip longitudinal axis, so that a stop is produced. In the assembled position, the upper pin is inserted and supported on the tensioning lever. Because the length of the spring band strip is shorter than the length of the unloaded tensioning spring, this can thus be fixed conditionally in the pre-tensioned position by the two-sided pin support of the spring band strip.

Now if the tensioning device is installed, then the upper pin is removed, so that the tensioning spring becomes unloaded. Then, in addition to the pre-tensioning function, as a second function, the movement limiting of the tensioning spring path is given to the spring band strip. This is because the tensioning spring can be unloaded only as far as the end of the spring band stop permits. If this runs, namely, against the tensioning lever, then the spring path is limited.

A disadvantage in this construction is, first, that it has a relatively expensive and complicated design with respect to the individual parts that are used, in particular, as concerns the assembly. In addition, the spring band strip remains within the tensioning device or the helical spring after removing the upper pin. If the stop is not contacted, then the spring band strip is not tensioned and consequently is movable, so that it can vibrate, which possibly leads to the generation of noise.

### SUMMARY

The invention is based on the objective of providing a tensioning device that allows the tensioning spring to be kept pre-tensioned, but that has a simultaneously simple construction.

To meet this objective for a tensioning device of the type noted above, it is provided according to the invention that a holding element that extends from the lever arm to the spring holder and that can be detached from both is provided for holding the tensioning device in a position with the pre-tensioned tensioning spring.

In the tensioning device, the holding element is arranged detachably on the lever arm as well as on the spring holder; thus, it can be removed. In addition, the holding element is a single piece and arranged or fastened on the appropriate part, that is, any external objects, such as connection pins or the like are not required. This results in a tensioning device that has a significantly simpler design and also a more economical production and that also does not tend to generate noise during operation after the holding element is removed.

According to a first construction of the invention, the holding element is constructed as a pin that extends from the lever arm to the spring holder and that has, on both ends, locking sections that are locked on the lever arm and on the spring holder in the assembled position. For releasing the fixed position of the tensioning spring, the holding element that is tensioned by the spring tension is merely unloaded somewhat and then released from its locked position on the lever arm and on the spring holder. This is easily possible during the installation of the tensioning device.

The pin itself preferably engages through the spring holder in a corresponding opening and extends through the tensioning spring and also through or in a spring support provided on the tensioning lever. With its other end, the tensioning spring is supported against this spring support. The pin is then locked on the spring support. A force-optimized locking is also possible due to the orientation of the pin running somewhat axial with respect to the tensioning spring and also the spring direction.

The locking section of the pin provided on the end locked on the spring support is preferably constructed in the form of a bend that can be brought into a position engaging behind an abutment shoulder on the spring support by twisting the pin after it is inserted into or passed through the spring support. For assembly, when the tensioning spring is compressed, the pin is merely to be guided through the spring holder and the tensioning spring and into or through the spring support and then twisted, for example, by ca. 90°, so that the bend on the end side engages behind the abutment shoulder. In this way, the pin is locked on this end. When the tensioning spring is relieved of pressure, the abutment shoulder is pressed against the bend and in this way limits the spring path in connection with the locking of the other pin end. The locking section of the pin that can be locked on the spring holder is preferably realized in an improvement of the invention in the form of a bend transitioning into a handle. This allows, first, the locking section to be constructed in a simple way and, second, the pin can be easily moved and twisted and pulled out from the tensioning device.

In one alternative to the use of a pin, the holding element is constructed as a tensioning band extending between the lever arm and the spring holder. The band itself is flexible, but in each case is mounted detachably on the lever arm and also on the spring holder. For this purpose, according to a first alternative of the invention, the tensioning band can form a ring and can be guided around a guide section on the lever arm and a guide section on the spring holder. For assembly, the lever arm and the spring holder are compressed, according to which the annular tensioning band is placed around the guide sections. Now if force is removed from the tensioning spring, then the spring path is limited by the tensioning band placed on the guide sections. The tensioning band itself can be a metal or plastic band and is preferably formed from a band section that is dimensioned accordingly in its length and whose ends are connected by an adhesive, crimped, or welded connection for the formation of the ring. For this purpose, a crimping sleeve or the like can be used, as well as the two band ends being either welded together metallically or fused thermally for a plastic band.

The guide section provided on the tensioning lever is preferably constructed on a spring support holding the tensioning spring or else as a lateral projection directly on the tensioning section. The guide section provided on the spring holder is preferably formed by the bottom side of the spring holder. In each case, the tensioning band also lies somewhat axial to the tensioning spring or to the spring force direction, so that here, despite fixation in the pre-tensioned state, none or only a negligible tilting moment is exerted on the spring.

In another alternative construction for use of a tensioning band, this does not have an annular construction but instead holders are provided connected on its two ends rigidly to the tensioning band, wherein, in the assembled position, these holders are inserted and locked in holder receptacles provided on the lever arm and on the spring holder. These holders can involve, for example, rigidly connected holding bolts or the like that are inserted into correspondingly shaped receptacles on the lever arm or on the spring holder. The locking is here performed by corresponding shaping of the holders and also their receptacles that can have, for example, a round or triangular or some other shape in cross section. Here, the assembly and disassembly is also extremely simple. All that is necessary is to compress the tensioning spring somewhat, in order to insert or remove the tensioning band with its holders into or out of the receptacles. In this way, force is again removed from the tensioning spring.

### BRIEF DESCRIPTION OF THE DRAWINGS

Additional advantages and details of the invention will be described below using embodiments with reference to the figures. The figures are schematic diagrams and show:

FIG. 1 is a schematic diagram of a first embodiment of a tensioning device according to the invention,

FIG. 2 is a schematic diagram of a second embodiment of a tensioning device according to the invention, and

FIG. 3 is a partial view of a third embodiment of a tensioning device according to the invention.

### DETAILED DESCRIPTION OF THE PREFERRED EMBODIMENTS

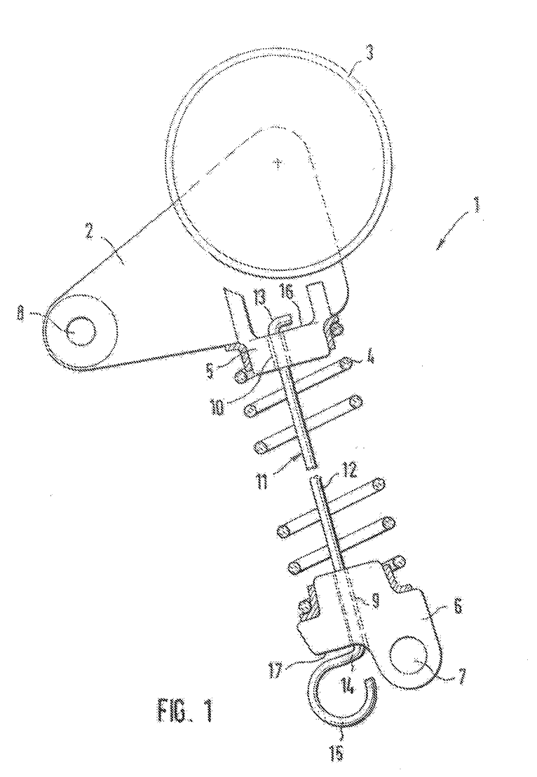

FIG. 1 shows a tensioning device 1 according to the invention comprising a tensioning lever 2 on which here a tensioning roller 3 is arranged. In the assembled position, a traction mechanism, primarily a belt, is guided over this tensioning roller. The tensioning device 1 further comprises a tensioning spring 4 that is constructed here as a helical spring and is supported with its end facing the tensioning lever 2 on a spring support 5 that is connected rigidly to the tensioning lever 2 or is a part of the tensioning lever. The other end of the tensioning spring 4 is supported on a spring holder 6. The spring holder 6 is attached to an external object, for example, the motor vehicle engine or the like, for which the attachment borehole 7 is used. Using this borehole, the tensioning device is supported there so that it can pivot. Accordingly, the tensioning lever 2 also provides an attachment borehole 8 with which it can be attached to an external object so that it can pivot.

Now, in order to be able to construct and deliver the tensioning device 1 with a pre-tensioned tensioning spring, it is necessary to lock the tensioning spring 4 in the compressed state. Here, on the spring holder 6 an elongated, essentially central opening 9 is provided. A corresponding opening 10 is provided on the spring support 5. A holding element 11 in the form of a pin 12 is guided through the openings 9 and 10 and also through the helical spring 4. On its end facing the tensioning lever 2, the pin 12 has a bend 13 that forms a locking section. On the opposite end, another bend 14 is provided that transitions into a handle 15. The pin 9 is now guided through the opening 9 with the end having the bend 13, wherein for passing through, the pin 12 is turned by ca. 90° with respect to the position shown in FIG. 1. That is, the opening 9 as well as the opening 10 have an elongated construction viewed in cross section, so that the pin with the bend 13 can be pushed through. The width, however, in particular, of the opening 10, is dimensioned so that the pin can no longer slide through when it is rotated to the position shown in FIG. 1. The pin 12 is first pushed through the opening 9, through the tensioning spring 4, and then through the opening 10 and then turned by ca. 90° to achieve the position shown in FIG. 1. In this position, the bend 13 engages an abutment shoulder 16 that is provided on the spring support 5 or is formed by the free, upper support surface. Now, if this holding force is removed from the tensioning spring 4, it forces the tensioning lever 2 and the spring support 6 apart. Here, the bend 13 contacts the abutment shoulder 16, while the bend 14 contacts the contact side 17 of the spring holder 6. In this way, the spring path is limited. The tensioning spring 4 can be locked in the pre-tensioned position.

For releasing the lock, the pin 12 merely has to be unloaded somewhat, so that it can be turned back by 90° using the handle 15 and can then be removed again from the opening 10, the helical spring 4, and also the opening 9.

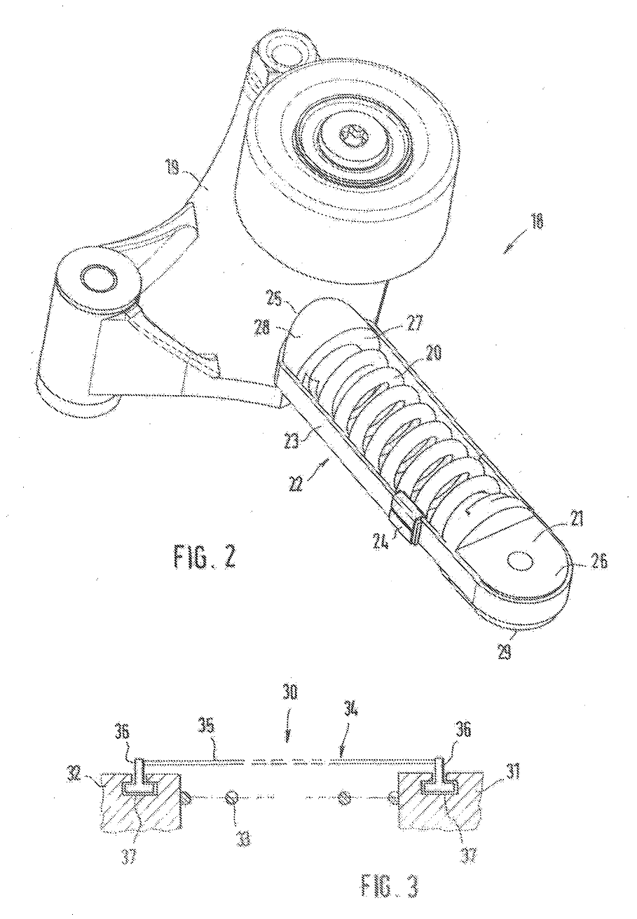

FIG. 2 shows another tensioning device 18 according to the invention, similarly comprising a tensioning lever 19, a tensioning spring 20, and also a spring holder 21. The function and the basic construction correspond to what was described with respect to FIG. 1.

Here, a holding element 22 is also provided for fixing the tensioning device 18 with a pre-tensioned tensioning spring 20. This holding element 22 is here constructed in the form of an annular tensioning band 23 that can be made from plastic or metal. The tensioning band 23 that is made from an elongated band section, whose band ends are fixed together by a crimping element 24 in the illustrated embodiment, thus closing the tensioning band into an annular shape, that is guided around a guide section 25 on the tensioning lever and also a guide section 26 on the spring holder 21. The guide section 25 on the tensioning lever projects laterally. It forms the spring support 27 by itself or such a part is attached to it. The tensioning spring 20 is supported against this spring support 27. The guide section 25 is formed by the outside of this projection 28. The outside has a curved construction.

The guide section 26 on the spring holder 21 is formed by the outer surface of the bottom side 29 of the spring holder 21 opposite the side on which the tensioning spring 20 is supported. This outer surface 29 also has a round construction.

Now, for assembling the tensioning band 23, the tensioning device 18 is pressed together. Therefore, the tensioning spring 20 is compressed. Then the already closed tensioning band 23 is placed around the guide sections 25 and 26, after which force is removed from the tensioning spring 20 again and the tensioning band 23 is clamped, here, however, limiting the spring path. For detaching the tensioning band 23, the tensioning spring 20 is merely compressed somewhat again, after which the tensioning band 23 can be easily removed by hand. It would also be natural to separate the tensioning band with shears or pincers. Then, however, it cannot be reused.

FIG. 3 finally shows another embodiment of a tensioning device 30 according to the invention in a partial view, wherein here only a section view through the spring holder 31 and the spring support 32 is shown. Also here, for fixing the pretensioned tensioning spring 33, a holding element 34 is used in the form of a tensioning band 35. However, non-detachable, end holders 36 that are constructed with a T-shaped cross section are provided on this holding element. On the spring holder 31 and on the spring support 32 there are correspondingly shaped holder receptacles 37 in which the holders 36 can be inserted from the side. In this way, the tensioning spring 33 can also be fixed in the pre-tensioned position, according to which the tensioning band 35 locked by the holders 36 limits the movement path. For release, the tensioning spring 33 is merely compressed somewhat and the holders 36 are pulled out from the holder receptacles 37 that are open on the side.

Finally, it is to be stated that the term “tensioning band” is to be understood generally and comprises not only flat bands, but also, e.g., a cord made from, e.g., plastic or a wire strand, or the like, closed into a ring.

### REFERENCE NUMBERS

1 Tensioning device
2 Tensioning lever
3 Tensioning roller
4 Tensioning spring
5 Spring support
6 Spring holder
7 Attachment borehole
8 Attachment borehole
9 Opening
10 Opening
11 Holding element
12 Pin
13 Bend
14 Bend
15 Handle
16 Abutment shoulder
17 Contact side
18 Tensioning device
19 Tensioning lever
20 Tensioning spring
21 Spring holder
22 Holding element
23 Tensioning band
24 Crimping element
25 Guide section
26 Guide section
27 Spring support
28 Projection
29 Outer surface
30 Tensioning device
31 Spring holder
32 Spring support
33 Tensioning spring
34 Holding element
35 Tensioning band
36 Holders
37 Holding receptacles

1. Tensioning device for a traction mechanism, comprising a lever arm over which the traction mechanism is guided and on which a tensioning spring is arranged with one end and a second end of which is arranged on a spring holder by which the tensioning device can be attached to an external object, a holding element extends from the lever arm to the spring holder and is arranged detachably at both ends to hold the tensioning device in a position with the tensioning spring pre-tensioned.

2. Tensioning device according to claim 1, wherein the holding element is a pin that extends from the lever arm to the spring holder and has locking sections on both of the ends that are locked in an assembled position on the lever arm and on the spring holder.

3. Tensioning device according to claim 2, wherein the pin is guided through the spring holder and the tensioning spring and through or in a spring support provided on the tensioning lever, wherein the pin is locked on the spring support.

4. Tensioning device according to claim 3, wherein the locking section provided on the end locked on the spring support is constructed as a bend that can be brought into a position engaging behind an abutment shoulder on the spring support through rotation of the pin after insertion into or the pin having passed through the spring support.

5. Tensioning device according to claim 4, wherein the locking section of the pin that can be locked on the spring holder is formed by a bend transitioning into a handle.

6. Tensioning device according to claim 1, wherein the holding element is constructed as a tensioning band that extends between the lever arm and the spring holder.

7. Tensioning device according to claim 6, wherein the tensioning band forms a ring and is guided around a guide section on the lever arm and a guide section on the spring holder.

8. Tensioning device according to claim 7, wherein the tensioning band is formed by an adhesive, crimped, or welded connection into a peripheral ring band.

9. Tensioning device according to claim 7, wherein the guide section provided on the tensioning lever is constructed on a spring support holding the tensioning spring.

10. Tensioning device according to claim 7, wherein the guide section provided on the spring holder is formed by a bottom side of the spring holder itself.

11. Tensioning device according to claim 6, wherein on both ends on the tensioning band, there are holders that are inserted and locked in an assembled position in holder receptacles provided on the lever arm or a spring support provided on the lever arm and on the spring holder.

12. Tensioning device according to claim 6, wherein the tensioning band is made from metal or plastic.
